(19) United States
(12) Patent Application Publication
(10) Pub. No.: US 2025/0271318 A1
(43) Pub. Date: Aug. 28, 2025

(54) PRESSURE SENSOR WITH MOLDED SUBSTRATE

(71) Applicant: Vishay Semiconductor GmbH, Heilbronn (DE)

(72) Inventors: Kevin Cromwell, Heilbronn (DE); Jan Willem Goldau, Talheim (DE)

(73) Assignee: Vishay Semiconductor GmbH, Heilbronn (DE)

(21) Appl. No.: 18/590,507

(22) Filed: Feb. 28, 2024

(51) Int. Cl. G01L 9/00; G01L 19/00

(52) U.S. Cl. CPC G01L 9/0055; G01L 19/0069

(57) ABSTRACT

A pressure sensor and method of making the same including a body supporting at least one conductive structure. The body can be an injection molded polymer body having a diaphragm on which at least a portion of the at least one conductive structure is supported. The diaphragm can include one or more stiffening structures. The thickness of the diaphragm and the stiffening structures can be selected to adapt the pressure sensor to a wide range of pressures.

### FIELD OF THE INVENTION

The present disclosure relates to sensing devices in general, and more particularly, to pressure sensors for sensing pressure.

### BACKGROUND

Pressure sensors are widely used in various applications such as aerospace, automotive, medical, consumer, wearables, industrial, HVAC, home automation and more. Such pressure sensors may be of a piezoresistive type, a piezoelectric type and/or a capacitive type, for example.

A conventional semiconductor piezoresistive sensor generally comprises a semiconductor base, a piezoresistive element and a circuit. The base, such as a monocrystalline silicon or metal alloy base, comprises a diaphragm. The piezoresistive element is disposed within the diaphragm for serving as the sensing device of the semiconductor piezoresistive sensor. The circuit is electrically connected with the piezoresistive element and the circuit comprises, for example, a complementary metal oxide semiconductor (CMOS), a bridge circuit, an amplifier circuit or a logic circuit for receiving and processing the signal output from the piezoresistive element. A typical sensor is supported on an aluminum substrate.

One type of sensing element comprises a Wheatstone bridge arrangement or other types of bridges, which is an electrical circuit that can measure small variations in electrical resistance. The circuit of a Wheatstone bridge arrangement is designed for a divided bridge circuit having four resistances with two pairs parallel to each other. The structure is used to measure the change of electrical resistance induced by the applied pressure of one pair compared to the other. In conventional pressure sensors, the materials generally do not include a polymer structure.

Conventional pressure sensors are generally made at least in part using a lithographic process. In addition, conventional pressure sensors may employ physical vapor deposition techniques. Further, the manufacture of conventional pressure sensors requires careful handling of small substrates. Generally, a clean room is needed in the manufacture of conventional pressure sensors. Moreover, the materials used to manufacture conventional pressure sensors may be expensive.

There is a need for a pressure sensor that addresses the problems of conventional pressure sensors.

There is accordingly a need for a pressure sensor that avoids or minimizes the use of lithography, physical vapor deposition techniques, or the handling of small substrates.

There is further the need for a pressure sensor that uses cost-effective materials.

There is further the need for a pressure sensor that uses cost-effective machinery.

There is further the need for a pressure sensor that does not require a clean room for manufacturing.

There is further the need for a pressure sensor that does not require handling of small substrates or single devices.

There is further the need for a pressure sensor that addresses the adhesion and/or application problems at high temperature and/or high pressures.

There is further the need for a sensor that does not require a self-temperature compensating gauges.

Aspects of the present disclosure address these needs.

### SUMMARY OF THE INVENTION

Aspects of the present disclosure are directed to a pressure sensor comprising a body defining a diaphragm, and at least one conductive structure supported at least partially on the diaphragm of the body.

The body can include an injection molded polymer, a 3D printed polymer, and/or a machined polymer. The at least one conductive structure can include a Wheatstone bridge. The injection molded body can include threads for engaging with mating threads of an associated housing. The pressure sensor can include a capping layer covering at least a portion of the at least one conductive structure. The diaphragm can include at least one stiffening structure. The at least one stiffening structure can include a plurality of concentric circular ribs. The at least one conductive structure can include at least one of a hysteresis compensator or a temperature compensator. The at least one conductive structure can include at least metal.

In accordance with another aspect of the present disclosure, a method comprises forming a body, the body comprising a diaphragm, and forming at least one conductive structure at least partially on the diaphragm of the body.

Forming the body can include injection molding a polymer material, 3D printing a polymer material, and/or machining a polymer material. Forming at least one conductive structure can include electrolessly depositing a metal on the body. Forming at least one conductive structure can include removing a portion of the deposited metal from the body. Electrolessly depositing a metal can include using an electroless nickel immersion gold process. Forming at least one conductive structure can include forming a Wheatstone bridge. The method can include forming a capping layer over at least a portion of the at least one conductive structure. The method can include creating an opening in the capping layer by removing a portion of the capping layer to expose a portion of the at least one conductive structure, and filling the opening with a conductive material. Forming the capping layer can include injection molding the capping layer with an opening exposing a portion of the at least one conductive structure, and further include filling the opening with a conductive material. Forming the body can include forming a cylindrical threaded body.

In accordance with another aspect of the present disclosure, a body for a pressure sensor comprises a molded polymer body having a diaphragm for supporting a conductive structure, and threads for engaging mating threads of an associated housing.

### BRIEF DESCRIPTION OF THE DRAWINGS

Embodiments of the invention are illustrated by way of example and not by way of limitation in the accompanying drawings and in which like reference numerals refer to similar elements.

FIG. 1 is a perspective cut-away view of an exemplary pressure transducer including a pressure sensor in accordance with the present disclosure.

FIG. 2 is a perspective view of a body of a pressure sensor in accordance with the present disclosure.

FIG. 3 is a top view of the body of FIG. 2.

FIG. 4 is a bottom view of the body of FIG. 2.

FIG. 5 is a perspective cross-sectional view taken through a dimeter of the body of FIG. 2.

FIG. 6 is a cross-sectional view taken through a diameter of the body of FIG. 2.

FIG. 7 is an enlarged portion of FIG. 6.

FIG. 8 is a flow chart of a method in accordance with the present disclosure.

FIG. 9A is schematic diagram of a structure after a first step of the method of FIG. 8.

FIG. 9B is schematic diagram of a structure after a second step of the method of FIG. 8.

FIG. 9C is schematic diagram of a structure after a third step of the method of FIG. 8.

FIG. 9D is schematic diagram of a structure after a fourth step of the method of FIG. 8.

FIG. 9E is schematic diagram of a structure after a fifth step of the method of FIG. 8.

FIG. 10 is a flow chart of another method in accordance with the present disclosure.

FIG. 11A is schematic diagram of a structure after a first step of the method of FIG. 10.

FIG. 11B is schematic diagram of a structure after a second step of the method of FIG. 10.

FIG. 11C is schematic diagram of a structure after a third step of the method of FIG. 10.

FIG. 11D is schematic diagram of a structure after a fourth step of the method of FIG. 10.

FIG. 11E is schematic diagram of a structure after a fifth step of the method of FIG. 10.

FIG. 11F is schematic diagram of a structure after a sixth step of the method of FIG. 10.

FIG. 12 is a flow chart of another method in accordance with the present disclosure.

FIG. 13A is schematic diagram of a structure after a first step of the method of FIG. 12.

FIG. 13B is schematic diagram of a structure after a second step of the method of FIG. 12.

FIG. 13C is schematic diagram of a structure after a third step of the method of FIG. 12.

FIG. 13D is schematic diagram of a structure after a fourth step of the method of FIG. 12.

FIG. 14 is a perspective view of a pressure sensor with spring-loaded contacts in accordance with the present disclosure.

FIG. 15 is a cross-sectional view of a spring-loaded contact in accordance with the present disclosure.

FIG. 16 is a cross-sectional view of an exemplary pressure transducer including a pressure sensor and spring-loaded contacts in accordance with the present disclosure.

FIG. 17 is a first perspective cross-sectional view of the pressure transducer of FIG. 16.

FIG. 18 is a second perspective cross-sectional view of the pressure transducer of FIG. 16.

### DETAILED DESCRIPTION

The description provided herein is to enable those skilled in the art to make and use the described embodiments set forth. Various modifications, equivalents, variations, combinations, and alternatives, however, will remain readily apparent to those skilled in the art. Any and all such modifications, variations, equivalents, combinations, and alternatives are intended to fall within the spirit and scope of the present invention defined by claims.

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology comprises the words above specifically mentioned, derivatives thereof, and words of similar import. The phrase “at least one” followed by a list of two or more items, such as “A, B, or C,” means any individual one of A, B or C as well as any combination thereof.

Disclosed herein are embodiments of a pressure sensor, and method of making the same, including a molded substrate or body. In a preferred embodiment, the molded substrate is an injection molded polymer substrate.

One advantage of a pressure sensor in accordance with the present disclosure is that the molded polymer substrate is inexpensive compared to current technology utilizing, for example, aluminum alloy substrates. Further, the disclosed pressure sensor and methods for making the same are more easily constructed as they avoid or seek to minimize the use of lithography, physical vapor deposition and handling of small substrates or single sensors, in the manufacturing process, but not limited to these.

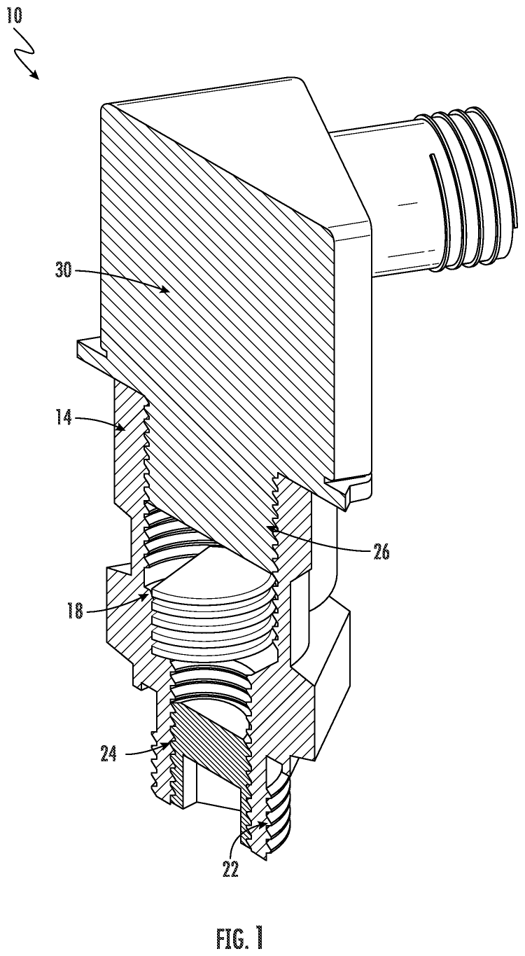

In FIG. 1, an exemplary pressure transducer is illustrated and identified generally by reference numeral 10. The pressure transducer 10 comprises a housing 14 in which a screw-in style pressure sensor 18 in accordance with the present disclosure is supported. A first end of the housing 14 comprises male threads 22 configured to be screwed into a pressure sensor port, such as a pressure sensor port of a manifold, for example. A pressure compensator 24 can be provided for accommodating pressure peaks. A second end of the housing 14 comprises female threads 26 adapted to receive and engage a male threaded portion of an electrical connector 30. The pressure transducer 10 is exemplary nature, and it will be appreciated that a pressure sensor 18 in accordance with the present disclosure can be used in a wide variety of pressure transducer arrangements. In addition, a pressure sensor 18 in accordance with the present disclosure can take other forms besides the illustrated the screw-in style pressure sensor 18.

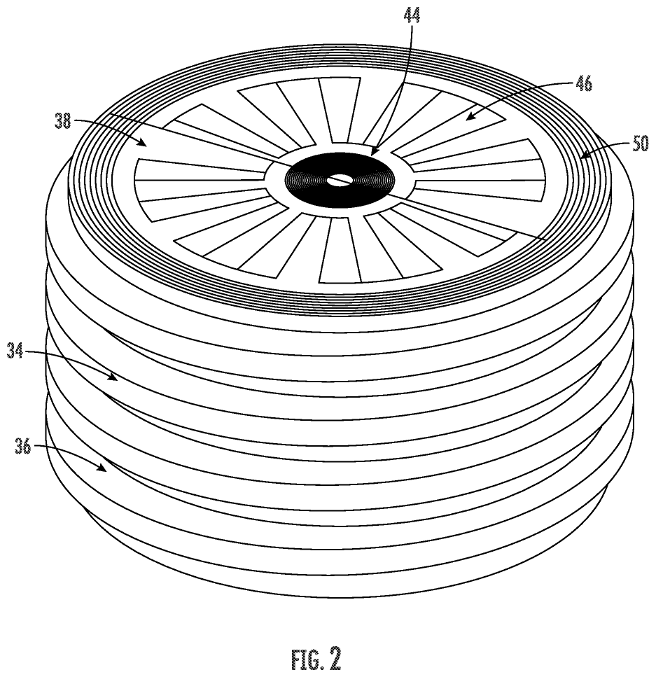

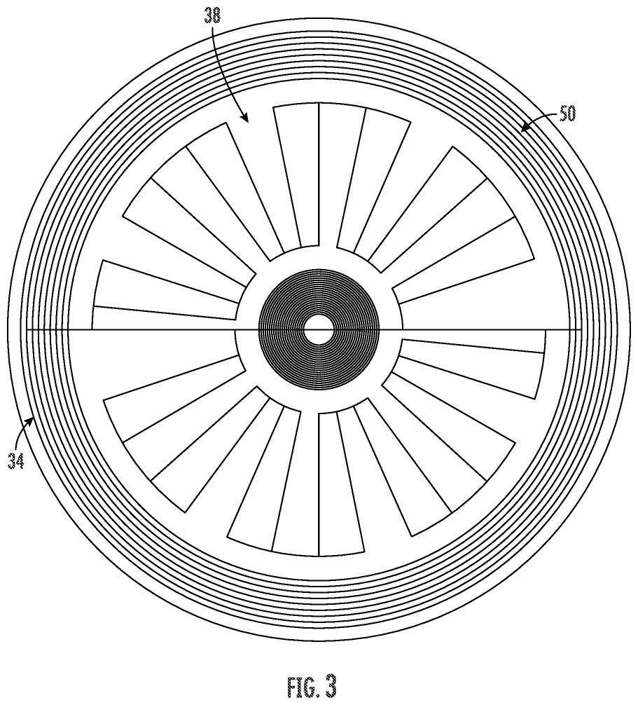

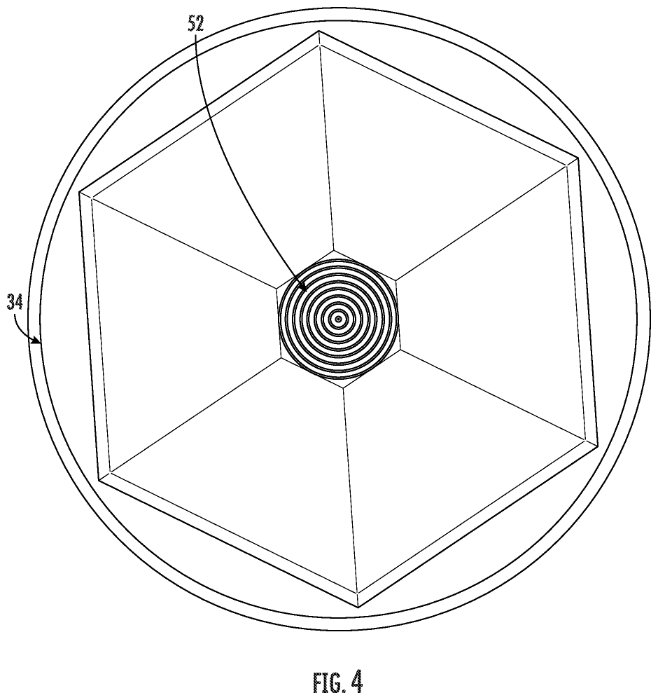

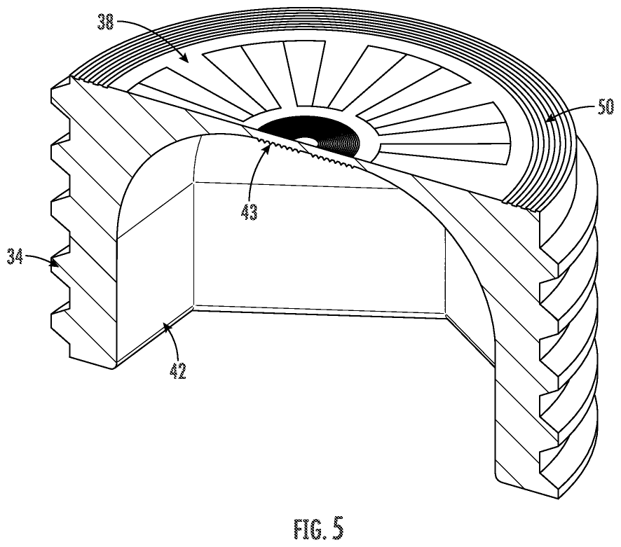

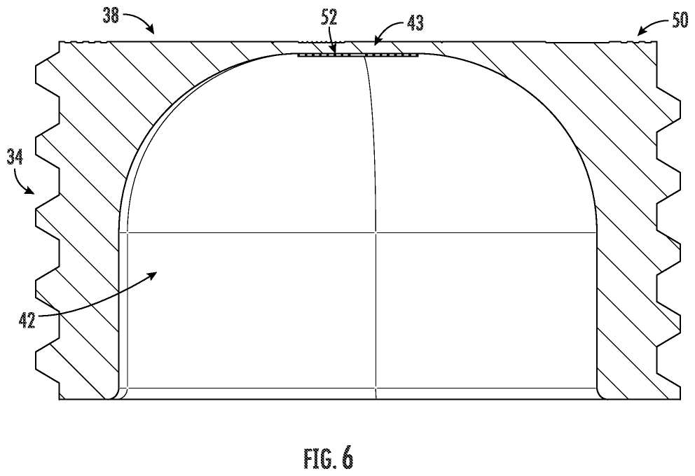

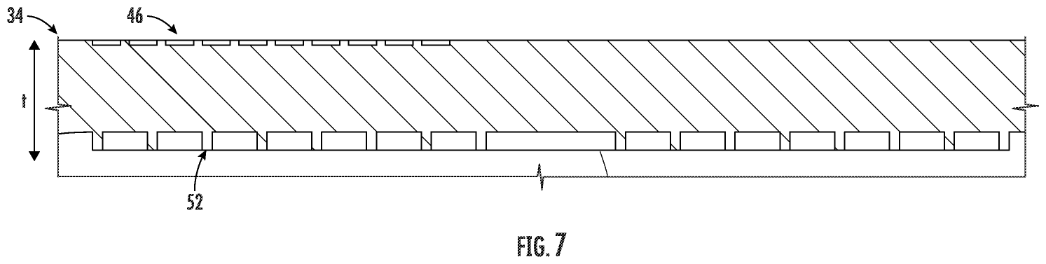

Turning to FIGS. 2-7, an illustrative pressure sensor 18 comprises a body 34 having threads 36, a top portion 38 and a cavity 42. The top portion 38 defines a diaphragm 43 having inner and outer surface structures 44 and 46 in which conductive structures 48 for sensing pressure and/or compensating for temperature and/or hysteresis are supported. The conductive structures 48 of the outer surface structures 46 are reference structures to measure the difference in resistance compared to the conductive structures 48 of the inner surface structures 44, which enables measuring a difference in resistivity between the structures induced by applied pressure and/or temperature and/or hysteresis.

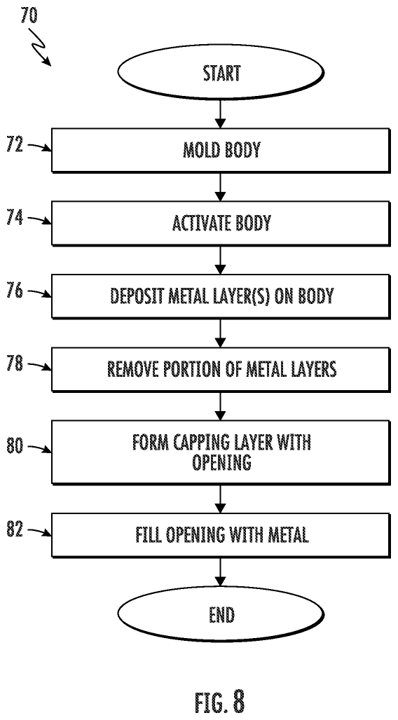

The body 34 in FIGS. 2-7 is shown prior to formation of the conductive structures 48. The conductive structures 48 can include, for example, a Wheatstone bridge. Formation of the conductive structures 48 on the body 34 is described in detail below in connection with remaining FIGS. 8-13D.

The surface structures 46 generally comprise patterns of alternating ridges and recesses. The recesses are configured to receive a metal layer and ultimately define a shape of the one or more conductive structures 48, as described below. Deflection of the diaphragm 43 in response to pressure changes in the cavity 42 result in changes in the electrical characteristics of one or more of the electric structures 48 that can be detected and correlated to an absolute pressure, a differential pressure, or a gauge pressure. The top portion 38 also comprises radial contact structures 50 for contacting the electrical connector 30 when assembled in the transducer 10. The specific details related to the conductive structures 48 are well-known, and a person of skill in the art will recognize that a wide variety conductive structures can be used in connection with various aspects of the present disclosure.

In accordance with the present disclosure, the body 34 comprises a molded, preferably cylindrical structure. In some embodiments, the body 34 can be an injection molded polymeric material, such as Polyether ether ketone (PEEK). Additional exemplary materials include any high-performance or engineering polymer including any fiber-reinforced variants (glass-or aramid-fibers), such as PI, PAI, PEKK, PEK, PEKEKK, LCP, PP, PPS, PA, PES, PPSU, PEI, PSIJ, PTFE, PFA, PVDF. In some embodiments, the body 34 can be a molded metallic material, such as aluminum, formed by powder injection molding, for example. It should be appreciated that multiple bodies (e.g., hundreds, or more) can be formed in a single molding process.

The diaphragm 43 of the body 34 can be configured to achieve a suitable deflection based on an anticipated pressure range and the specific material used for the body 34. In this regard, the thickness t of the diaphragm 43 may be thicker for higher pressure applications and thinner for lower pressure application. In addition, stiffening structures in the form of ribs 52 can be provided on body 34 as shown in the illustrated embodiment. The ribs 52 can have a shape and/or size to achieve a suitable deflection of the diaphragm 43. In the illustrated embodiment, the ribs 52 are circular and concentrically arranged, but other types of stiffening structure are possible in addition to or in place of the ribs 52. Typically, the ribs 52 are formed during molding of the body 34.

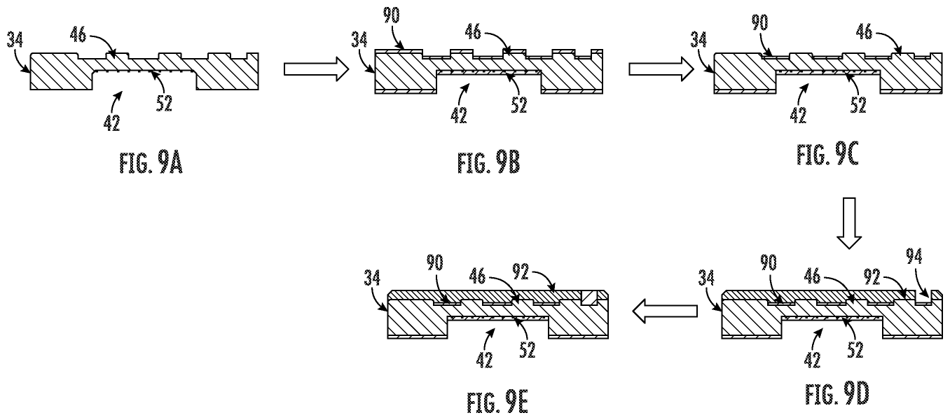

In FIG. 8, an exemplary method of forming a pressure sensor 18 with a molded body 34 in accordance with the present disclosure is identified generally by reference numeral 70. FIGS. 9A-9E schematically illustrate the resulting structure during the various steps of the method 70.

The method 70 begins with process step 72 wherein the body 34 is molded. As noted above, the body is typically formed in an injection molding process using a polymer material. FIG. 9A illustrates an exemplary molded body 34 with cavity 42, surface structures 46., and ribs 52. In process step 74, the body 34 is activated in preparation to receive one or more metallic layers. Optionally, a doped polymer material can be used such that activation in process step 74 is not required. Activation of the body 34 can be performed by chemical, mechanical or laser abrasion, for example.

In process step 76, a metal layer is deposited on the body 34. FIG. 9B illustrates a metal layer or layers 90 deposited on surfaces of the body 34. The metal layer or layers 90 can include, for example, Ni—P, NiP—Au, Co, NiB, Cu, Al, or any other suitable material. It will be appreciated that any suitable process can be used for depositing the metal layer or layers 90, such as electroless nickel immersion gold (ENIG) process. ENIG is an electroless deposition based on autocatalytic reaction. The ENIG process may be performed with or without gold (Au). In one example, the ENIG process on polymer can include degreasing of the surfaces of the body 34 with an alkaline solution to improve uniformity and adhesion, surface roughening of the body 34 with sulfuric acid to increase total surface area and hydrophilicity, sensitization using a sensitization bath including adsorption of Sn nuclei to prepare bonding sites to facilitate Pd deposition, activation with an activation bath including deposition of Pd as deposition seed (catalyst) for NiP, reduction with a reduction bath to increase catalytic activity of surface and prevent contamination, and electroless plating with an electroless plating bath to deposit NiP.

In process step 78, portions of the metal layer or layers 90 are removed. Typically, the removal of portions of the metal layer or layers 90 is performed by grinding and/or laser ablation or any other suitable process. FIG. 9C illustrates the body 34 after removal of portions of the metal layer or layers 90. In process step 80, an optional capping layer 92 is formed by injection molding. The capping layer 92 can be made of, for example, any material suitable for the body 34 set forth above, but with a lower glass-transition temperature compared to the body material to enable a second injection molding. In this example, an opening 94 is formed during the injection molding process leaving a portion of the metal layer or layer 90 exposed. FIG. 9D illustrates the body 34 after process step 78. In process step 82, the opening 94 is filled with metal in a second ENIG process without the need of another activation. FIG. 9E illustrates the body 34 after process step 80.

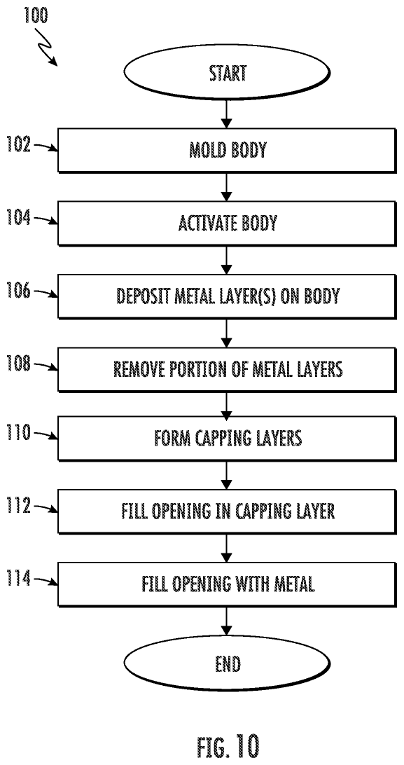

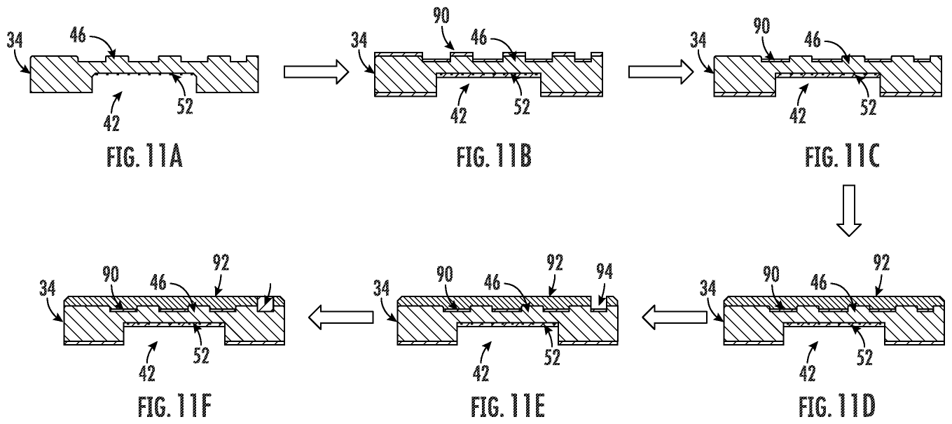

FIG. 10 illustrates another exemplary method of forming a pressure sensor 18 with a molded body 34 in accordance with the present disclosure identified generally by reference numeral 100. FIGS. 11A-11F schematically illustrate the resulting structure during the various steps of the method 100.

The method 100 begins with process step 102 wherein the body 34 is molded. As noted above, the body is typically formed in an injection molding process. FIG. 11A illustrates an exemplary molded body 34 with cavity 42, ribs 52 and surface structures 46. In process step 104, the body 34 is activated in preparation to receive one or more metallic layers. Activation of the body 34 can be performed by chemical, mechanical or laser abrasion.

In process step 106, a metal layer is deposited on the body 34. FIG. 11B illustrates a metal layer or layers 90 deposited on surfaces of the body 34. The metal layer or layers 90 can include, for example, Ni—P, NiP—Au, Co, NiB, Cu, Al, or any other suitable material. It will be appreciated that any suitable process can be used for depositing the metal layer or layers 90, such electroless nickel immersion gold process (ENIG growth w/o Au), for example. ENIG is an electroless deposition based on autocatalytic reaction. In one example, the ENIG process on polymer can include degreasing of the surfaces of the body 34 with an alkaline solution to improve uniformity and adhesion, surface roughening of the body 34 with sulfuric acid to increase total surface area and hydrophilicity, sensitization using a sensitization bath including adsorption of Sn nuclei to prepare bonding sites to facilitate Pd deposition, activation with an activation bath including deposition of Pd as deposition seed (catalyst) for NiP, reduction with a reduction bath to increase catalytic activity of surface and prevent contamination, and electroless plating with an electroless plating bath to deposit NiP.

In process step 108, portions of the metal layer or layers 90 are removed. Typically, the removal of portions of the metal layer or layers 90 is performed by grinding and/or laser ablation or any other suitable process. FIG. 11C illustrates the body 34 after removal of portions of the metal layer or layers 90. In process step 110, an optional capping layer 92 is formed by injection molding. The capping layer 92 can be made of, for example, any material suitable for the body 34 set forth above, but with a lower glass-transition temperature compared to the body material to enable a second injection molding. FIG. 11D illustrates the body 34 after process step 108. In process step 112, an opening 94 is formed in the capping layer 92 by removing a portion thereof, as shown in FIG. 11e. In process step 114, the opening 94 is filled with metal in a second ENIG process. FIG. 11F illustrates the body 34 after process step 80.

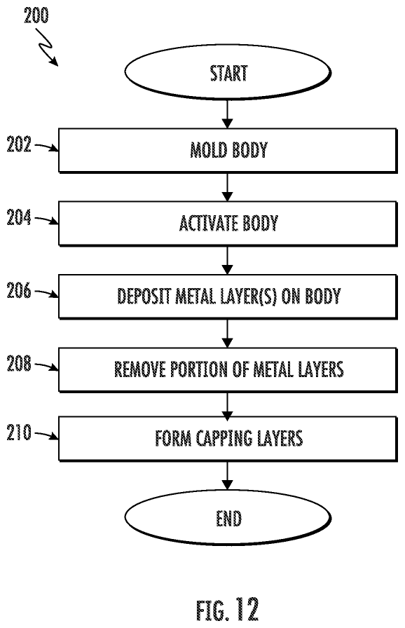

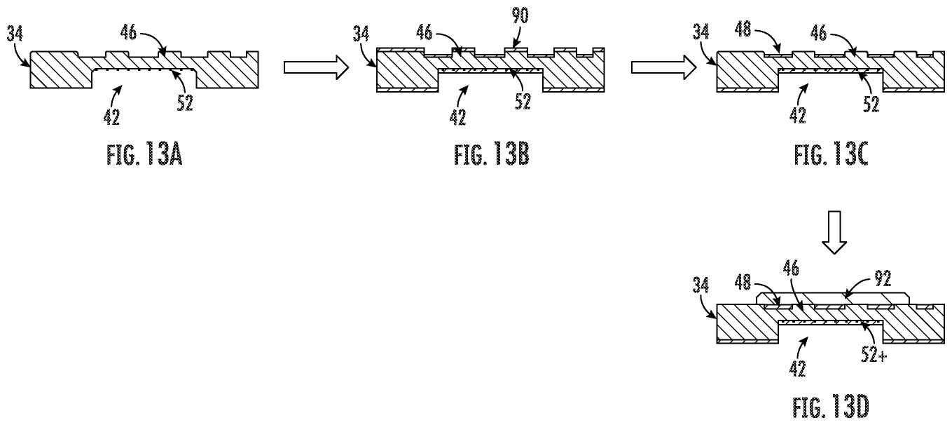

FIG. 12 illustrates another exemplary method of forming a pressure sensor 18 with a molded body 34 in accordance with the present disclosure identified generally by reference numeral 200. FIGS. 13A-13D schematically illustrate the resulting structure during the various steps of the method 200.

The method 200 begins with process step 202 wherein the body 34 is molded. As noted above, the body is typically formed in an injection molding process. FIG. 13A illustrates an exemplary molded body 34 with cavity 42, ribs 50 and surface structures 46. In process step 204, the body 34 is activated in preparation to receive one or more metallic layers. Activation of the body 34 can be performed by chemical, mechanical or laser abrasion.

In process step 206, a metal layer is deposited on the body 34. FIG. 13B illustrates a metal layer or layers 90 deposited on surfaces of the body 34. The metal layer or layers 90 can include, for example, Ni—P, NiP—Au, Co, NiB, Cu, Al, or any other suitable material. It will be appreciated that any suitable process can be used for depositing the metal layer or layers 90, such electroless nickel immersion gold process (ENIG growth w/o Au), for example. ENIG is an electroless deposition based on autocatalytic reaction. In one example, the ENIG process on polymer can include degreasing of the surfaces of the body 34 with an alkaline solution to improve uniformity and adhesion, surface roughening of the body 34 with sulfuric acid to increase total surface area and hydrophilicity, sensitization using a sensitization bath including adsorption of Sn nuclei to prepare bonding sites to facilitate Pd deposition, activation with an activation bath including deposition of Pd as deposition seed (catalyst) for NiP, reduction with a reduction bath to increase catalytic activity of surface and prevent contamination, and electroless plating with an electroless plating bath to deposit NiP.

In process step 208, portions of the metal layer or layers 90 are removed. Typically, the removal of portions of the metal layer or layers 90 is performed by grinding laser ablation or any other suitable process. FIG. 13C illustrates the body 34 after removal of portions of the metal layer or layers 90. In process step 210, an optional capping layer 92 is formed by injection molding. The capping layer 92 can be made of, for example, any material suitable for the body 34 set forth above, but with a lower glass-transition temperature compared to the body material to enable a second injection molding. In this embodiment, the capping layer 92 leaves portions of the metal layer or layers 90 exposed. FIG. 13D illustrates the body 34 after process step 210.

The conductive structures of embodiments of the present disclosure can have a size of, for example, 2 μm, with an overall pressure sensor size of approximately 5 mm. Pressure sensors in accordance with the present disclosure can be configured for sensing a wide range of pressures, such as between 0-3550 bar or greater.

Although the foregoing exemplary pressure sensors are piezo-resistive type pressure sensors, it will be appreciated that aspects of the present disclosure are applicable to capacitive type pressure sensors, or any other similar electronic devices.

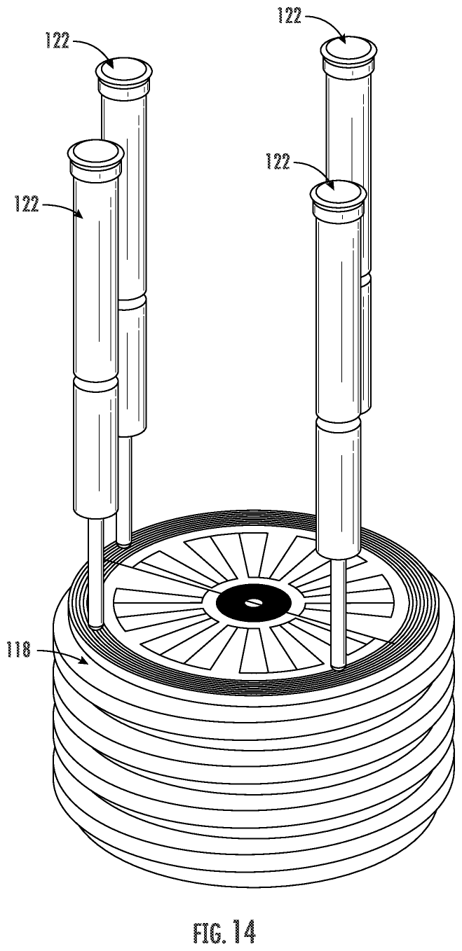

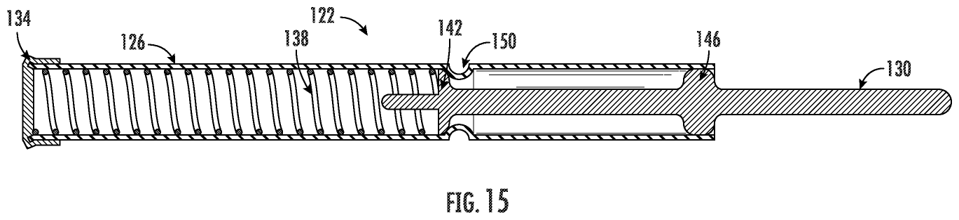

FIG. 14 illustrates an exemplary pressure sensor 118 and four spring-loaded contacts 122. The spring-loaded contacts 122 can be used for electrically coupling the pressure sensor 118 to an electrical connector, such as the electrical connector 30 in the assembly of FIG. 1. With additional reference to FIG. 15, each spring-loaded contact 122 includes a hollow body 126 in which a pin 130 is supported for reciprocating movement. The pin 130 extends from a first end of the body 126. An end cap 134 encloses a second end of the body 126. A spring 138 is interposed between the end cap 134 and the pin 130 and urges the pin 130 to the right in FIG. 15. The pin 130 includes first and second radial flanges 142 and 146 adapted to engage a radially-inwardly extending stop 150 of the body 126 to define the limits of axial movement of the pin 130 relative to the body 126.

It will be appreciated that the spring-loaded contacts 122 can facilitate device assembly particular in screw-in style applications where each sensor may be threaded into a corresponding device housing a different amount. In addition, the spring-loaded contacts 122 can compensate for changes resulting from thermal expansion/contraction.

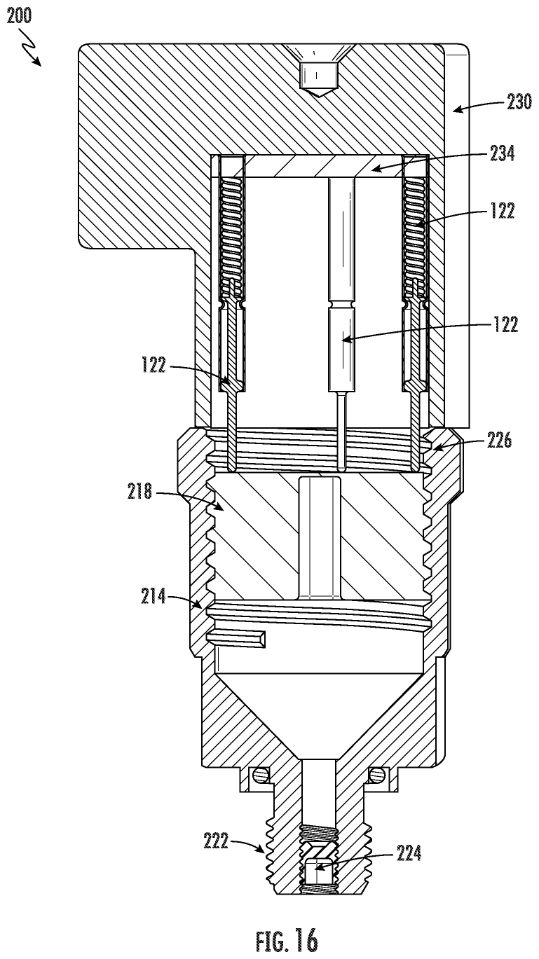

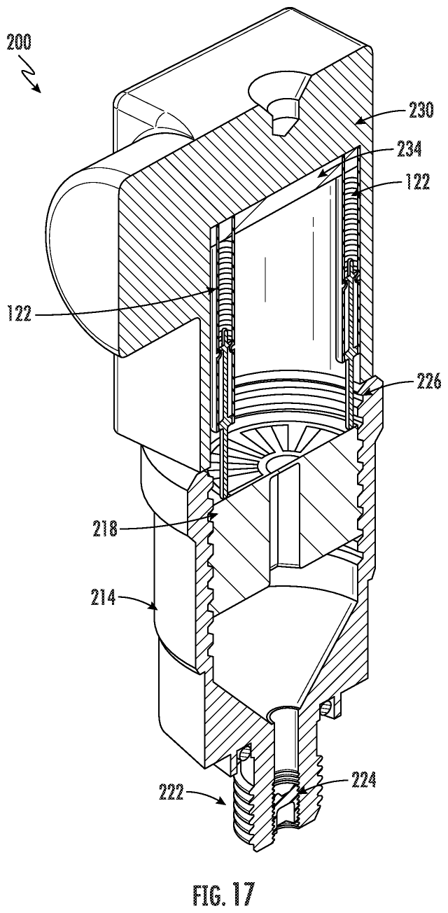

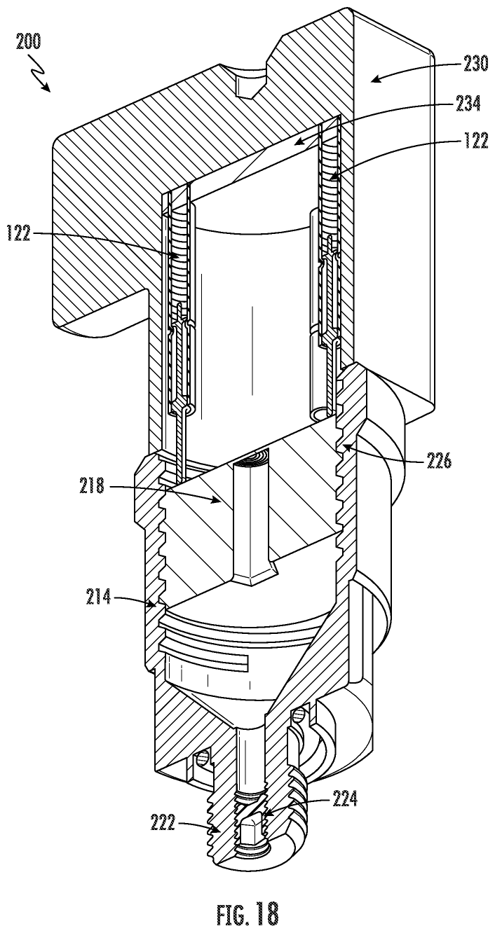

In FIGS. 16-18, an exemplary pressure transducer 200 including a pressure sensor in accordance with the present disclosure. The pressure transducer 200 comprises a housing 214 in which a screw-in style pressure sensor 218 in accordance with the present disclosure is supported. A first end of the housing 214 comprises male threads 222 configured to be screwed into a pressure sensor port, such as a pressure sensor port of a manifold, for example. A pressure compensator 224 can be provided for accommodating pressure peaks. A second end of the housing 214 comprises female threads 226 adapted to receive and engage a male threaded portion of an electrical connector 230. Multiple spring-loaded contacts 122 are connected to a PCB 234 which is supported in the electrical connector 230 and configured to electrically couple the pressure sensor 218 to the electrical connector 230.

In the foregoing examples, injection molding is used to form the bodies of the sensors. It will be appreciated that in other example, the bodies can be formed in other manners, such as 3D printing, machining, or other manufacturing processes.

Although the features and elements of the present invention are described in the example embodiments in particular combinations, each feature may be used alone without the other features and elements of the example embodiments or in various combinations with or without other features and elements of the present invention. Changes in the form and the proportion of components or parts as well as in the substitution of equivalents are contemplated as circumstances may suggest or render expedient without departing from the spirit or scope of the invention.

The foregoing descriptions have been presented for purposes of illustration and description. They are not intended to be exhaustive or to limit the invention to the precise forms disclosed, and many modifications and variations are possible in light of the above teachings. The invention is to be construed according to the claims and their equivalents.

What is claimed is:

1. A pressure sensor, comprising:
an polymer body defining a diaphragm; and
at least one conductive structure supported at least partially on the diaphragm of the body.

2. The pressure sensor according to claim 1, wherein the body includes at least one of an injection molded body, a 3D printed body, or a machined body.

3. The pressure sensor according to claim 1, wherein the at least one conductive structure comprises a Wheatstone bridge.

4. The pressure sensor according to claim 1, wherein the body comprises threads for engaging with mating threads of an associated housing.

5. The pressure sensor according to claim 1, further comprising a capping layer covering at least a portion of the at least one conductive structure.

6. The pressure sensor according to claim 1, wherein the diaphragm comprises at least one stiffening structure.

7. The pressure sensor according to claim 6, wherein the at least one stiffening structure comprises a plurality of concentric circular ribs.

8. The pressure sensor according to claim 1, wherein the at least one conductive structure comprises at least one of a hysteresis compensator or a temperature compensator.

9. The pressure sensor according to claim 1, wherein the at least one conductive structure comprises at least metal.

10. A method of forming a pressure sensor, the method comprising:
forming a polymer body having a diaphragm; and
forming at least one conductive structure at least partially on the diaphragm of the body.

11. The method according to claim 10, wherein forming the body includes at least one of injection molding a polymer material, 3D printing a polymer material, or machining a polymer material.

12. The method according to claim 10, wherein forming at least one conductive structure comprises electrolessly depositing a metal on the body.

13. The method according to claim 12, wherein forming at least one conductive structure comprises removing a portion of the deposited metal from the body.

14. The method according to claim 12, wherein electrolessly depositing a metal comprises using an electroless nickel immersion gold process.

15. The method according to claim 10, wherein forming at least one conductive structure comprises forming a Wheatstone bridge.

16. The method according to claim 10, further comprising forming a capping layer over at least a portion of the at least one conductive structure.

17. The method according to claim 16, further comprising creating an opening in the capping layer by removing a portion of the capping layer to expose a portion of the at least one conductive structure, and filling the opening with a conductive material.

18. The method according to claim 16, wherein forming the capping layer comprises injection molding the capping layer with an opening exposing a portion of the at least one conductive structure, and further comprising filling the opening with a conductive material.

19. The method according to claim 10, wherein forming the body comprises forming a cylindrical threaded body.

20. A body for a pressure sensor comprising:
a polymer body having a diaphragm for supporting a conductive structure, and threads for engaging mating threads of an associated housing.
